(19) United States
(12) Patent Application Publication
(10) Pub. No.: US 2010/0065530 A1
(43) Pub. Date: Mar. 18, 2010

(54) COMPOSITION AND PROCESS FOR THE SELECTIVE REMOVE OF TiSiN

(75) Inventors: Elizabeth Walker, Stockertown, PA (US); Emanuel I. Cooper, Scarsdale, NY (US); Jun Liu, Brookfield, CT (US); Bernhard D. Bernhard, Kooskia, ID (US)

Correspondence Address: MOORE & VAN ALLEN PLLC, P.O. BOX 13706, Research Triangle Park, NC, 27709, US

(73) Assignee: Advanced Technology Materials, Inc, Danbury, CT (US)

(21) Appl. No.: 12/525,600

(22) PCT Filed: Feb. 6, 2008
(86) PCT No.: PCT/US08/53142

§ 371 Date: Oct. 1, 2009

Related U.S. Application Data
(60) Provisional application No. 60/888,420, filed on Feb. 6, 2007.

(51) Int. Cl. B44C 1/22

(52) U.S. Cl. 216/13; 252/79.1; 252/79.3

(57) ABSTRACT

An aqueous removal composition and process for removing heater material, including TiSiN, from a microelectronic device having said material thereon. The aqueous removal composition includes at least one fluoride source, at least one passivating agent, and at least one oxidizing agent. The composition selectively removes TiSiN relative to oxides and nitrides that are adjacently present.

### FIELD OF THE INVENTION

The present invention relates to aqueous compositions for the removal of heater material, including TiSiN-containing material, from microelectronic devices and methods of using the same.

### DESCRIPTION OF THE RELATED ART

Nonvolatile memory devices retain their stored data even when their power supplies are turned off. For example, one widely used type of nonvolatile memory device is the flash memory device. Recently, other types of nonvolatile memory devices such as phase change memory devices are being used in place of flash memory devices in some applications. Phase change memory devices are currently of interest because of non-volatilization, higher speed, low power dissipation, high reliability, high device integration, and higher number of rewrites.

A phase change memory refers to a device that uses a phase-change material, typically including a chalcogenide, i.e., materials that may be electrically switched between a generally amorphous and a generally crystalline state, for electronic memory applications. Phase change materials typically use the Joule heating resulting from a current as a heat source for changing the crystalline state of a portion of the phase change material. Importantly, the state of the phase change material is non-volatile in that, when set in either a crystalline, semi-crystalline, amorphous, or semi-amorphous state, each of which is represented by a unique resistance value, that value is retained until changed by another programming event, i.e., Joule heating. The state is unaffected by removing electrical power.

Conventional phase change memories require programming currents to convert the phase change materials between the different states. Desirably, these programming currents are kept as small as possible in order to reduce power consumption. Generally, a heater is positioned under a phase change material and the current through the heater is responsible for changing the state of at least an overlying volume of the phase change material. For example, a higher current and fast quenching freezes the phase change material in a high resistance, amorphous state. A long pulse, medium current recrystallizes the phase change material to form a low resistance, crystalline state. The low resistance state may, for instance, correspond to a stored, logic “one,” while the high resistance state may correspond to a stored, logic “zero.”

It is well known that unless considerable current is provided to convert a substantial region of the overlying phase change material, the converted region of amorphous phase change material, i.e., reset, may be insufficient to prevent some current from passing past the converted material. The current flow at a small read voltage may be interpreted electrically as a low resistance state even though the region directly above the heater is amorphous. To overcome this deficiency, a higher current is used to create a larger heated mushroom and the phase change material along these potential leakage paths is converted from crystalline to amorphous, allowing the cell to reach a completely reset state, but at the expense of considerable current consumption. To overcome this disadvantage, a confined arrangement of the heater and the phase change material has been proposed (see, e.g., U.S. Patent Application Publication No. 2006/0257787 in the name of Kuo et al.). As a result of the confined arrangement between the heater and the phase change material, there is no need for the extra current creating a mushroom over the heater to prevent current from bypassing the amorphous region of a reset bit. Thus, in some embodiments, current consumption may be reduced, which may be particularly advantageous in mobile applications.

U.S. Patent Application Publication No. 2006/0257787 discloses, in part, the “dip back” process of a confined arrangement phase memory device whereby the heater material is selectively removed without substantially damaging the sidewall spacer or dielectric layer material. FIG. 1 illustrates a generic example of a confined arrangement phase memory device including a conductor layer 12 (which may sit atop at least one layer selected from the group consisting of a substrate, an interlayer dielectric, and combinations thereof); a dielectric layer, e.g., SiO₂, 14; sidewall spacers, e.g., Si₃N₄ or carbon-containing silicon nitrides, 16; and the heater material, e.g., TiSiN, 18. It is noted that the sidewall spacers may be flared or planarized to yield substantially vertical sidewalls. During the dip-back, the heater material 18 may be removed using a dry or wet etch process to produce a gap or pore 20. Thereafter, a phase change material, e.g., a chalcogenide, may be deposited in the pore 20.

Several objectives of the dip-back composition and process include the attainment of a certain pore 20 depth at a preferred temperature for a preferred length of time, said pore having substantially the same depth at the center and the edges of said pore (see, e.g., FIG. 2), and no more than negligible corrosion of the heater material. In order to achieve this, the dip-back composition must be formulated, in part, to selectively remove heater material relative to dielectric material and sidewall spacer material. Moreover, the dip-back composition must be “tunable” to remove variations of the heater material, e.g., TiSiN variants having more or less silicon content, more or less titanium content, and potentially some carbon content.

Towards that end, it is an object of the present invention to provide improved aqueous compositions for the selective removal of heater material, including TiSiN, from microelectronic devices, relative to low-k dielectric and nitride material that are adjacently present on said microelectronic device.

### SUMMARY OF THE INVENTION

The present invention generally relates to an aqueous composition to remove heater material, including TiSiN, from a microelectronic device having same thereon. The present invention further relates to method of using said composition to remove heater material, or other layers including TiSiN, from a microelectronic device having same thereon. Preferably, the aqueous composition includes at least one highly acidic fluoride source, at least one passivating agent, and at least one oxidizing agent and selectively removes heater material relative to adjacently present oxides and nitrides.

In one aspect, the invention relates to an aqueous removal composition comprising at least one fluoride source, at least one passivating agent, and at least one oxidizing agent, wherein said aqueous removal composition etchingly removes heater material from a microelectronic device having same thereon. Preferably, the at least one fluoride source, at least one passivating agent, and at least one oxidizing agent are present in amounts effective to achieve an etch rate of heater material in a range from about 100 Å min⁻¹ to about 200 Å min⁻¹ at temperatures in a range from about 30° C. to about 70° C.

In another aspect, the invention relates to an aqueous removal composition comprising at least one fluoride source, at least one passivating agent, and at least one oxidizing agent, wherein said aqueous removal composition etchingly removes TiSiN from a microelectronic device having same thereon. Preferably, the at least one fluoride source, at least one passivating agent, and at least one oxidizing agent are present in amounts effective to achieve an etch rate of TiSiN in a range from about 100 Å min⁻¹ to about 200 Å min⁻¹ at temperatures in a range from about 30° C. to about 70° C.

In still another aspect, the invention relates to an aqueous removal composition consisting essentially of at least one fluoride source, at least one passivating agent, at least one oxidizing agent, and water, wherein said aqueous removal composition etchingly removes TiSiN from a microelectronic device having same thereon. Preferably, the at least one fluoride source, at least one passivating agent, and at least one oxidizing agent are present in amounts effective to achieve an etch rate of TiSiN in a range from about 100 Å min⁻¹ to about 200 Å min⁻¹ at temperatures in a range from about 30° C. to about 70° C.

In yet another aspect, the invention relates to an aqueous removal composition consisting of at least one fluoride source, at least one passivating agent, at least one oxidizing agent, and water, wherein said aqueous removal composition etchingly removes TiSiN from a microelectronic device having same thereon. Preferably, the at least one fluoride source consists of fluoroboric acid, the at least one passivating agent consists of boric acid, and the at least one oxidizing agent consists of hydrogen peroxide. Preferably, the at least one fluoride source, at least one passivating agent, and at least one oxidizing agent are present in amounts effective to achieve an etch rate of TiSiN in a range from about 100 Å min⁻¹ to about 200 Å min⁻¹ at temperatures in a range from about 30° C. to about 70° C.

Yet another aspect of the invention relates to a kit comprising, in one or more containers, one or more of the following reagents for forming an aqueous removal composition, said one or more reagents selected from the group consisting of at least one fluoride source, at least one passivating agent, and at least one oxidizing agent, and wherein the kit is adapted to form an aqueous removal composition suitable for removing heater material from a microelectronic device having said material thereon.

Another aspect of the invention relates to a method of removing heater material from a microelectronic device having said material thereon, said method comprising contacting the microelectronic device with an aqueous removal composition for sufficient time and under sufficient contacting conditions to at least partially remove said material from the microelectronic device, wherein the aqueous removal composition includes at least one fluoride source, at least one passivating agent, and at least one oxidizing agent. Preferably, the at least one fluoride source, at least one passivating agent, and at least one oxidizing agent are present in amounts effective to achieve an etch rate of TiSiN in a range from about 100 Å min⁻¹ to about 200 Å min⁻¹ at temperatures in a range from about 30° C. to about 70° C.

Still another aspect of the invention relates to improved microelectronic devices and microelectronic device structures, and products incorporating same, made using the methods of the invention comprising contacting the microelectronic device structure with an aqueous removal composition for sufficient time and under sufficient contacting conditions to at least partially remove heater material from the microelectronic device, using the methods and/or compositions described herein, and optionally, incorporating the microelectronic device structure into a product (e.g., microelectronic device).

Another aspect of the invention relates to an article of manufacture comprising a removal composition of the invention, a microelectronic device, and heater material, wherein the removal composition comprises at least one fluoride source, at least one passivating agent, and at least one oxidizing agent.

Other aspects, features and advantages of the invention will be more fully apparent from the ensuing disclosure and appended claims.

### BRIEF DESCRIPTION OF THE DRAWINGS

FIG. 1 is general illustration of the heater of a phase change memory device before and after the dip-back process whereby a portion of the heater material is removed.

FIG. 2 is a general illustration of the center and edge of the pore that is formed during the dip-back process.

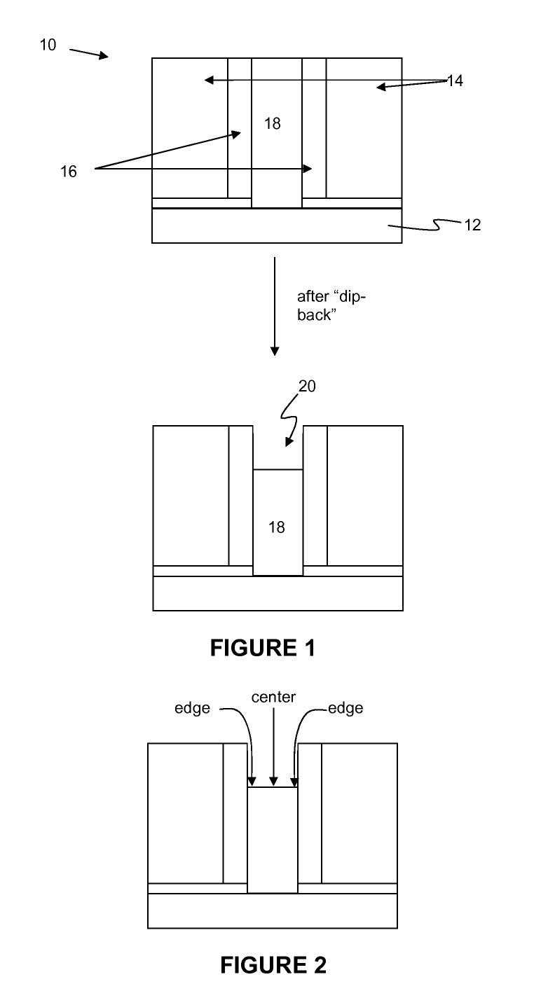

### DETAILED DESCRIPTION OF THE INVENTION, AND PREFERRED EMBODIMENTS THEREOF

The present invention relates to compositions for efficiently and selectively removing heater material from a phase change memory device. Preferably, the compositions of the invention selectively remove heater material, including variations of titanium silicon nitride (TiSiN), relative to low-k dielectric and sidewall spacer layers adjacent to said heater material.

For ease of reference, “microelectronic device” corresponds to any substrate including non-volatile, phase change memory devices (e.g., PCM, PRAM, Ovonic Unified Memory, Chalcogenide RAM (CRAM)), semiconductor substrates, flat panel displays, and microelectromechanical systems (MEMS), manufactured for use in microelectronic, integrated circuit, or computer chip applications. It is to be understood that the term “microelectronic device” is not meant to be limiting in any way and includes any substrate including a phase change memory device that will eventually become a microelectronic device or microelectronic assembly.

As defined herein, “low-k dielectric material” corresponds to any material used as a dielectric material in a layered microelectronic device, wherein the material preferably has a dielectric constant less than about 3.5. Preferably, the low-k dielectric materials include low-polarity materials such as silicon oxide, silicon-containing organic polymers, silicon-containing hybrid organic/inorganic materials, organosilicate glass (OSG), TEOS, fluorinated silicate glass (FSG), silicon dioxide, and carbon-doped oxide (CDO) glass. It is to be appreciated that the low-k dielectric materials may have varying densities and varying porosities.

As defined herein, “sidewall spacer” corresponds to a conventionally formed nitride layer deposited within a feature such as a via or hole within a low-k dielectric layer. Following deposition, the sidewall spacer may be anisotropically etched such that the diameter at the top of the feature is greater than the diameter at the bottom of the feature, i.e., flared. The sidewall spacer may be alternatively planarized to substantially eliminate the flare, i.e, the diameter at the top of the feature is approximately equal to the diameter at the bottom of the feature.

As defined herein, “heater material” corresponds to resistive materials including the formula nc-MN/a-Si₃N₄, and wherein M comprises a metal selected from the group consisting of Ti, W, Mo, Nb, Zr, Hf and combinations thereof, including nc-TiN/a-Si₃N₄, which includes nanocrystalline grains TiN immersed in an amorphous matrix of Si₃N₄ having a hardness value in excess of 40 GPa (Veprek, S., et al., Thin Solid Films, 268 (1995) 64; Veprek S., et al., Appl. Phys. Lett., 66(20) (1995) 2640; Veprek, S., et al., J. Vac. Sci. Technol., A14(1) (1996) 46; Veprek, S., et al., Surf Coat. Technol., 86-87 (1996) 394). Other heater materials include SiGe alloys, NiCr, Ta, AlTiN, and TaSiN. For ease of reference, nc-TiN/a-Si₃N₄ will hereinafter be referred to as TiSiN but said reference is not meant to limit the heater material to just TiSiN. It is noted that variations of TiSiN are achievable whereby the silicon and titanium content in the TiSiN material may be varied, as readily determined by one skilled in the art. In addition, it should be appreciated that the deposited TiSiN may include carbon, which also may be varied.

As used herein, “about” is intended to correspond to ±5% of the stated value.

“Substantially devoid” is defined herein as less than 2 wt. %, preferably less than 1 wt. %, more preferably less than 0.5 wt. %, even more preferably less than 0.1 wt. %, and most preferably 0 wt. %.

As defined herein, “post-etch residue” corresponds to material remaining following gas-phase plasma etching processes, e.g., BEOL dual damascene processing. The post-etch residue may be organic, organometallic, organosilicic, or inorganic in nature, for example, silicon-containing material, carbon-based organic material, and etch gas residue including, but not limited to, oxygen and fluorine.

Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

In one aspect, the present invention relates to removal compositions including at least one fluoride source, at least one low-k passivating agent, at least one oxidizing agent, and water, for removing heater material from the surface of a microelectronic device having same thereon, wherein the heater material is selected from the group consisting of nc-MN/a-Si₃N₄, SiGe alloys, NiCr, Ta, AlTiN, and TaSiN, and combinations thereof, and wherein Me comprises a metal selected from the group consisting of Ti, W, Mo, Nb, Zr, Hf and combinations thereof. Preferably, the heater material comprises TiSiN. In one embodiment, the removal compositions of the invention include borofluoric acid, boric acid, hydrogen peroxide, and water. In yet another embodiment, the removal compositions of the invention consist essentially of borofluoric acid, boric acid, hydrogen peroxide, and water. In still another embodiment, the removal compositions of the invention consist of borofluoric acid, boric acid, hydrogen peroxide, and water. In still another embodiment, the removal compositions of the invention include at least one fluoride source, at least one low-k passivating agent, at least one oxidizing agent, at least one buffering agent, and water. In another embodiment, the removal compositions of the invention include borofluoric acid, boric acid, hydrogen peroxide, at least one buffering agent, and water. In still another embodiment, the removal compositions of the invention consist essentially of borofluoric acid, boric acid, hydrogen peroxide, at least one buffering agent, and water. In yet another embodiment, the removal compositions of the invention consist of borofluoric acid, boric acid, hydrogen peroxide, at least one buffering agent, and water. In each case, the removal composition preferably has a heater material, e.g., TiSiN, removal rate in a range from about 100 Å min⁻¹ to about 200 Å min⁻¹ at temperatures in a range from about 30° C. to about 70° C., preferably about 45° C. to about 55° C. It should be appreciated by one skilled in the art that materials vary based on the deposition conditions (e.g., starting materials and the process of deposition) and as such, the etching/dissolving behavior of the TiSiN materials may vary as well.

In one embodiment, the present invention relates to an aqueous removal composition including at least one fluoride source, at least one low-k passivating agent, at least one oxidizing agent, and water, for removing heater material from the surface of a microelectronic device having same thereon, wherein the heater material comprises nc-MN/a-Si₃N₄, and wherein M comprises a metal selected from the group consisting of Ti, W, V, Nb, Zr, and combinations thereof. Preferably, the heater material comprises TiSiN. The range of weight percent ratios of the components of the removal composition relative to the fluoride source is as follows:

| | | preferred | most preferred |
|---|---|---|---|
| | | weight % | weight |
| components | weight % ratio | ratio | % ratio |
| passivating agent to | about 0.001:1 to | about 0.1:1 to | about 0.4:1 to |
| fluoride source | about 10:1 | about 4:1 | about 2:1 |
| oxidizing agent to | about 25:1 to | about 50:1 to | about 100:1 to |
| fluoride source | about 600:1 | about 200:1 | about 200:1 |

In a particularly preferred embodiment, the range of weight percent ratios for passivating agent to fluoride source is in a range from about 0.3:1 to about 0.9:1, and oxidizing agent to fluoride source is in a range from about 90:1 to about 110:1.

Put another way, the amount of passivating agent(s), fluoride source(s) and oxidizing agent(s) in the removal composition, based on the total weight of the composition, is as follows:

| components | weight % | preferred weight % | most preferred weight % |
|---|---|---|---|
| passivating agent(s) | about 0.001% to | about 0.02% to about | about 0.1% to about |
| | about 2% | 1% | 0.3% |
| fluoride source(s) | about 0.001% to | about 0.01% to about | about 0.05% to about |
| | about 3% | 1% | 0.3% |
| oxidizing agent(s) | about 1% to about | about 10% to about | about 20% to about |
| | 50% | 30% | 30% |
| water | about 45% to about | about 68% to about | about 69.4% to about |
| | 98.998% | 89.97% | 79.85% |

The water is preferably deionized. In a preferred embodiment of the invention, the removal composition is substantially devoid of oxalic acid and chlorine-containing compounds, and the amount of fluoroboric acid, based on the total weight of the composition, is less than 2.5 wt. %. In addition, the removal composition is preferably substantially devoid of monoethanolamine, monoethanolammonium salts, persulfate and abrasive or other inorganic particulate material.

The pH range of the removal composition is about 0 to about 5, preferably about 0 to about 4.5, and most preferably about 0 to about 2.5. In a particularly preferred embodiment, the pH of the removal composition is in a range from about 0.5 to about 1.5.

The strongly acidic fluoride source assists in breaking up and solubilizing the heater material. Fluoride sources contemplated herein include, but are not limited to, hydrofluoric acid, ammonium fluoride, ammonium bifluoride, fluorosilicic acid, fluoroboric acid, and combinations thereof. Preferably, the etchant source comprises fluoroboric acid.

The low-k passivating agents are included to reduce the chemical attack of the low-k layers and to protect the wafer from additional oxidation. Boric acid is a presently preferred low-k passivating agent, although other hydroxyl additives may also be advantageously employed for such purpose, e.g., 3-hydroxy-2-naphthoic acid, malonic acid, and iminodiacetic acid. Amphiphilic molecules, such as diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, and combinations thereof, may also be employed for such purpose. Preferably, less than 2 wt. % of the underlying low-k material is etched/removed using the removal compositions of the present invention, more preferably less than 1 wt. %, most preferably less than 0.5 wt. %, based on the total weight of the underlying low-k material.

Oxidizing agents contemplated herein include, but are not limited to, hydrogen peroxide (H₂O₂), oxone, oxone tetrabutylammonium salt, ferric nitrate (Fe(NO₃)₃), potassium iodate (KIO₃), potassium permanganate (KMnO₄), nitric acid (HNO₃), ammonium chlorite (NH₄ClO₂), ammonium chlorate (NH₄ClO₃), ammonium iodate (NH₄IO₃), ammonium perborate (NH₄BO₃), ammonium perchlorate (NH₄ClO₄), ammonium periodate (NH₄IO₃), ammonium persulfate ((NH₄)₂S₂O₈), sodium persulfate (Na₂S₂O₈), potassium persulfate (K₂S₂O₈), tetramethylammonium chlorite ((N(CH₃)₄)ClO₂), tetramethylammonium chlorate ((N(CH₃)₄)ClO₃), tetramethylammonium iodate ((N(CH₃)₄)IO₃), tetramethylammonium perborate ((N(CH₃)₄)BO₃), tetramethylammonium perchlorate ((N(CH₃)₄)ClO₄), tetramethylammonium periodate ((N(CH₃)₄)IO₄), tetramethylammonium persulfate ((N(CH₃)₄)S₂O₈), urea hydrogen peroxide ((CO(NH₂)₂)H₂O₂)_{, peracetic acid (CH}₃(CO)OOH), N-methylmorpholine-N-oxide (NMMO); trimethylamine-N-oxide; triethylamine-N-oxide; pyridine-N-oxide; N-ethylmorpholine-N-oxide; N-methylpyrrolidine-N-oxide; N-ethylpyrrolidine-N-oxide, and combinations thereof. Preferably, the oxidizing agent includes hydrogen peroxide. The oxidizing agent may be introduced to the composition at the manufacturer, prior to introduction of the composition to the device wafer, or alternatively at the device wafer, i.e., in situ.

The removal composition of the invention may further include a buffering system, wherein said buffering system maintains the pH of the composition in a range from about 0 to about 5, preferably about 0 to about 4.5, and most preferably about 0 to about 2.5. Buffering agents include phthalic acid and ammonium hydroxide; phosphoric acid, diammonium phosphate and ammonium hydroxide; and phosphoric acid and ammonium hydroxide.

In various preferred embodiments, the removal composition is formulated in the following Formulations A-AB, wherein all percentages are by weight, based on the total weight of the formulation. Buffer 1 corresponds to 0.08 M phthalic acid in ammonium hydroxide and buffer 2 corresponds to 1 M phosphoric acid and diammonium phosphate buffer adjusted with ammonium hydroxide.

| | wt. % | | wt. % | wt. % | |
|---|---|---|---|---|---|
| Formulation | B(OH)₃ | wt. % HBF₄ | H₂O₂ | water^{†} | buffer |
| A | 0.048 | 0.12 | 12 | 87.83 | — |
| B | 0.048 | 0.12 | 24 | 75.83 | — |
| C | 0.048 | 0.48 | 12 | 87.47 | — |
| D | 0.048 | 0.48 | 24 | 75.47 | — |
| E | 0.192 | 0.12 | 12 | 87.69 | — |
| F | 0.192 | 0.12 | 24 | 75.69 | — |
| G | 0.192 | 0.48 | 12 | 87.33 | — |
| H | 0.192 | 0.48 | 24 | 75.33 | — |
| I | 0.12 | 0.3 | 18 | 81.58 | — |
| J | 0.012 | 0.3 | 18 | 81.69 | — |
| K | 0.228 | 0.3 | 18 | 81.47 | — |
| L | 0.12 | 0.03 | 18 | 81.85 | — |
| M | 0.12 | 0.57 | 18 | 81.31 | — |
| N | 0.12 | 0.3 | 9 | 90.58 | — |
| O | 0.12 | 0.3 | 27 | 72.58 | — |
| P | 0.24 | 0.144 | 12 | 87.62 | — |
| Q | 0.24 | 0.144 | 12 | balance | Buffer 1 (0.08M) |
| R | 0.12 | 0.288 | 24 | 75.59 | — |
| S | 0.12 | 0.288 | 12 | 87.59 | — |
| T | 0.12 | 0.576 | 12 | 87.30 | — |
| U | 0.24 | 0.288 | 12 | 87.47 | — |
| V | 0.24 | 0.576 | 12 | 87.48 | — |
| W | 0.24 | 0.144 | 12 | balance | Buffer 2 (1 M) |
| X | 0.024 | 0.288 | 12 | balance | Buffer 2 (1 M) |
| Y | 0.024 | 0.288 | 24 | balance | Buffer 2 (1 M) |
| Z | 0.12 | 0.288 | 12 | balance | Buffer 2 (1 M) |
| AA | 0.12 | 0.288 | 24 | balance | Buffer 2 (1 M) |
| AB | 0.24 | 0.144 | 24 | 75.62 | — |

^{†}rounded to the nearest hundredths place.

In another embodiment, the pH of the removal composition was raised by adding pH adjusting agents such as benzyltrimethylammonium hydroxide, benzyltriethylammonium hydroxide, benzyltributylammonium hydroxide, dimethyldiethylammonium hydroxide, tetramethyl ammonium hydroxide, tetraethyl ammonium hydroxide, tetrapropyl ammonium hydroxide, tetrabutyl ammonium hydroxide, ammonium hydroxide, or combinations thereof, which results in a less aggressive removal composition. In yet another embodiment, at least one chelating agent selected from the group consisting of amines (e.g., pentamethyldiethylenetriamine (PMDETA), monoethanolamine (MEA), triethanolamine (TEA)); amino acids (e.g., glycine, serine, proline, leucine, alanine, asparagine, aspartic acid, glutamine, valine, and lysine); carboxylic acids (e.g., citric acid, acetic acid, maleic acid, oxalic acid, malonic acid, and succinic acid); phosphonic acid; phosphonic acid derivatives (e.g., hydroxyethylidene diphosphonic acid (HEDP), 1-hydroxyethane-1,1-diphosphonic acid, nitrilo-tris(methylenephosphonic acid) (e.g., Dequest 2000EG, Solutia, Inc., St. Louis, Mo.), ethylenedinitrilotetra(methylenephosphonic) acid (EDTMP)); nitrilotriacetic acid; iminodiacetic acid; etidronic acid; ethylenediamine; ethylenediaminetetraacetic acid (EDTA); (1,2-cyclohexylenedinitrilo)tetraacetic acid (CDTA); uric acid; tetraglyme; 1,3,5-triazine-2,4,6-trithiol trisodium salt solution; 1,3,5-triazine-2,4,6-trithiol triammonium salt solution; sodium diethyldithiocarbamate; disubstituted dithiocarbamates (R¹(CH₂CH₂O)₂NR²CS₂Na) with one alkyl group (R²=hexyl, octyl, deceyl or dodecyl) and one oligoether (R¹(CH₂CH₂O)₂, where R¹=ethyl or butyl); Dequest 2000; Dequest 2010; Dequest 2060s; diethylenetriamine pentaacetic acid; propylenediamine tetraacetic acid; 2-hydroxypyridine 1-oxide; ethylendiamine disuccinic acid; sodium triphosphate penta basic; and combinations thereof, may be included in the removal composition. For example, 0.05 wt. % chelating agent may be added to the removal composition of the invention to make the formulation more aggressive towards the TiSiN and/or stabilize the oxidizing agent(s). These two embodiments provide alternative options for “tuning” the removal composition based on the makeup of the TiSiN material.

In another embodiment, the present invention relates to an aqueous removal composition comprising, consisting of, or consisting essentially of, at least one fluoride source, at least one low-k passivating agent, at least one oxidizing agent, water, optionally at least one buffering agent, optionally at least one pH adjusting agent, and optionally at least one chelating agent, for removing heater material from the surface of a microelectronic device having same thereon, wherein the heater material comprises nc-MN/a-Si₃N₄, and wherein M comprises a metal selected from the group consisting of Ti, W, V, Nb, Zr, and combinations thereof.

In another aspect of the present invention, any of the removal compositions described herein may further include heater material residue, wherein the heater material residue comprises residue material such as TiSiN, byproducts of TiSiN (e.g., TiN, Si₃N₄, SiF₄, TiO₂), and combinations thereof. For example, the removal compositions may comprise, consist essentially of, or consist of fluoroboric acid, boric acid, hydrogen peroxide, heater material residue, and water. Importantly, the residue material may be dissolved and/or suspended in the aqueous compositions of the invention.

In addition to the components listed herein, it is also contemplated herein that the removal compositions may further include complexing agents, surfactants, metal and metal alloy passivating agents, organic solvents, and compounds that will extend the bath-life of the removal composition.

It will be appreciated that in general removal applications, it is common practice to make concentrated forms to be diluted prior to use. For example, the removal composition may be manufactured in a more concentrated form, including at least one fluoride source and at least one low-k passivating agent, and thereafter diluted with water and/or the at least one oxidizing agent at the manufacturer, before use, and/or during use at the fab. Dilution ratios may be in a range from about 0.1 part diluent:1 part removal composition concentrate to about 5 parts diluent:1 part removal composition concentrate. For example, 4 parts of a 30% H₂O₂ diluent may be mixed with 1 part removal concentrate having a ratio of passivating agent to fluoride source in a range from about 0.4:1 to about 2:1 to yield a removal composition having a ratio of oxidizing agent to fluoride source in a range from about 100:1 to about 200:1. It is understood that upon dilution, the weight percent ratios of the components of the removal composition will remain unchanged.

The removal compositions of the invention are easily formulated by simple addition of the respective ingredients and mixing to homogeneous condition. Furthermore, the removal compositions may be readily formulated as single-package formulations or multi-part formulations that are mixed at or before the point of use, preferably multi-part formulations. The individual parts of the multi-part formulation may be mixed at the tool or in a mixing region/area such as an inline mixer or in a storage tank upstream of the tool. It is contemplated that the various parts of the multi-part formulation may contain any combination of ingredients/constituents that when mixed together form the desired removal composition. The concentrations of the respective ingredients may be widely varied in specific multiples of the removal composition, i.e., more dilute or more concentrated, in the broad practice of the invention, and it will be appreciated that the removal compositions of the invention can variously and alternatively comprise, consist or consist essentially of any combination of ingredients consistent with the disclosure herein.

Accordingly, another aspect of the invention relates to a kit including, in one or more containers, one or more components adapted to form the compositions of the invention. Preferably, the kit includes, in one or more containers, at least one fluoride source and at least one low-k passivating agent for combining with water and/or oxidizing agent(s) at the fab or the point of use. For example, the kit preferably includes, in one or more containers, fluoroboric acid and boric acid, for combining in a specific ratio with hydrogen peroxide and water at the fab. Optionally, the containers of the kit may include buffering agent(s), pH adjusting agent(s), chelating agent(s), and combinations thereof. The containers of the kit must be suitable for storing and shipping said removal compositions, for example, NOWPak® containers (Advanced Technology Materials, Inc., Danbury, Conn., USA). The one or more containers which contain the components of the removal composition preferably include means for bringing the components in said one or more containers in fluid communication for blending and dispense. For example, referring to the NOWPak® containers, gas pressure may be applied to the outside of a liner in said one or more containers to cause at least a portion of the contents of the liner to be discharged and hence enable fluid communication for blending and dispense. Alternatively, gas pressure may be applied to the head space of a conventional pressurizable container or a pump may be used to enable fluid communication. In addition, the system preferably includes a dispensing port for dispensing the blended removal composition to a process tool.

Substantially chemically inert, impurity-free, flexible and resilient polymeric film materials, such as high density polyethylene, are preferably used to fabricate the liners for said one or more containers. Desirable liner materials are processed without requiring co-extrusion or barrier layers, and without any pigments, UV inhibitors, or processing agents that may adversely affect the purity requirements for components to be disposed in the liner. A listing of desirable liner materials include films comprising virgin (additive-free) polyethylene, virgin polytetrafluoroethylene (PTFE), polypropylene, polyurethane, polyvinylidene chloride, polyvinylchloride, polyacetal, polystyrene, polyacrylonitrile, polybutylene, and so on. Preferred thicknesses of such liner materials are in a range from about 5 mils (0.005 inch) to about 30 mils (0.030 inch), as for example a thickness of 20 mils (0.020 inch).

Regarding the containers for the kits of the invention, the disclosures of the following patents and patent applications are hereby incorporated herein by reference in their respective entireties: U.S. Pat. No. 7,188,644 entitled “APPARATUS AND METHOD FOR MINIMIZING THE GENERATION OF PARTICLES IN ULTRAPURE LIQUIDS;” U.S. Pat. No. 6,698,619 entitled “RETURNABLE AND REUSABLE, BAG-IN-DRUM FLUID STORAGE AND DISPENSING CONTAINER SYSTEM;” and U.S. Patent Application No. 60/916,966 entitled “SYSTEMS AND METHODS FOR MATERIAL BLENDING AND DISTRIBUTION” filed on May 9, 2007 in the name of John E. Q. Hughes. As applied to microelectronic manufacturing operations, the removal compositions of the present invention are usefully employed to etchingly/dissolvingly remove heater material, e.g., TiSiN, from the surface of the microelectronic device, and may be applied to said surface before or after the application of other compositions formulated to remove alternative materials from the surface of the device. Importantly, the removal compositions of the invention selectively remove said heater material relative to adjacent oxides and nitrides and preferably the etch rate of heater material, e.g., TiSiN, is in a range from about 100 Å min⁻¹ to about 200 Å min⁻¹ at temperatures in a range from about 30° C. to about 70° C., preferably about 45° C. to about 55° C.

In heater material removal application, the removal composition is applied in any suitable manner to the device to be cleaned, e.g., by spraying the removal composition on the surface of the device to be cleaned, by dipping the device to be cleaned in a static or dynamic volume of the removal composition, by contacting the device to be cleaned with another material, e.g., a pad, or fibrous sorbent applicator element, that has the removal composition absorbed thereon, or by any other suitable means, manner or technique by which the removal composition is brought into removal contact with the device to be cleaned. Further, batch or single wafer processing is contemplated herein.

In use of the compositions of the invention for removing heater material from microelectronic devices having same thereon, the removal composition typically is contacted with the device for a time of from about 1 minute to about 30 minutes, preferably about 3 minutes to 10 minutes, and most preferably about 5 minutes to about 8 minutes, at temperature in a range of from about 25° C. to about 90° C., preferably about 30° C. to about 70° C., and most preferably about 45° C. to about 55° C. Such contacting times and temperatures are illustrative, and any other suitable time and temperature conditions may be employed that are efficacious to remove about 800 Å to about 1,200 Å of heater material, e.g., TiSiN, from the device in about 6 minutes to about 8 minutes, within the broad practice of the invention. Preferably, the amounts of the components and the contacting conditions are chosen to achieve a selectivity of TiSiN relative to Si₃N₄ in a range from about 5:1 to about 50:1, preferably about 10:1 to about 50:1.

It will be appreciated that the concentration of the oxidizing agent and/or the fluoride source in the removal composition may be monitored during contacting of the microelectronic device with the removal composition of the invention and the concentrations adjusted. For example, the removal composition may be sampled, manually and/or automatically, and the concentration of a component in the removal composition may be analyzed, using standard analytical techniques, and compared to the initial concentration of said component in the removal composition. An aliquot of a solution of said component may be added, either manually and/or automatically, to the bath to boost the concentration of the component to initial levels, as readily determined by one skilled in the art. It should be appreciated that the maintenance of the concentration of several components in the removal composition is dependent on how much loading of material(s) to be removed has occurred in said composition. As more and more compounds are dissolved therein, the solubility of many active components will actually decrease and eventually fresh removal composition will be required.

As an example, a system for generating hydrogen peroxide at a point of use comprising a hydrogen peroxide-using processing facility may comprise an electrochemical cell constructed and arranged for generating hydrogen peroxide, and a hydrogen peroxide monitoring and concentration control assembly including a analysis unit, e.g., a Karl Fischer analysis unit, comprising means for sampling fluid from the electrochemical cell and analyzing same, wherein the hydrogen peroxide monitoring and concentration control assembly includes means for real-time determination of concentration of the hydrogen peroxide based on the analysis.

As another example, a control unit functions as a process controller and is used to accurately control the automatic replenishment of the solvent components, in particular water, guaranteeing optimum and stable processing over an extended period of time. Once the component analyzer determines the relative composition of the solvent system, the process controller can restore the system to the correct component ratio. Specific limits are pre-programmed into the process controller for the specific component(s) being targeted for analysis. The results from the component analyzer are compared to these specification limits and, if determined to be below the minimum specification value, amounts of the target component can be injected into the solvent solution to restore the required component ratio. By maintaining the component ratio of the solvent system within predetermined limits, the effective bath life of the solvent mixture can be extended. Using the concentration analysis and solvent replenishment system of the invention to analyze the solution and adjust the water level, the bath life can be increased by at least 100%. This results in substantial savings in a) chemicals, b) downtime for chemical changes, and c) chemical disposal costs.

These and other SPC embodiments are disclosed in U.S. Pat. Nos. 7,214,537 and 7,153,690, both in the name of Russell Stevens, et al., and both of which are hereby incorporated by reference in their entirety.

Following the achievement of the desired removal action, the removal composition is readily removed from the device to which it has previously been applied, e.g., by rinse, wash, or other removal step(s), as may be desired and efficacious in a given end use application of the compositions of the present invention. For example, the device may be rinsed with a rinse solution including deionized water and/or dried (e.g., spin-dry, N₂, vapor-dry etc.). Following rinsing of the microelectronic device, a phase change material, e.g., a chalcogenide, may be deposited in the pore.

The removal compositions may be easily disposed of following the decomposition of the oxidizing agent and the neutralization of the fluoride source.

In addition, it should be appreciated that any of the removal compositions disclosed herein may be used during chemical mechanical polishing (CMP) processes, i.e., to selectively remove barrier layer materials, including titanium-containing (such as TiSiN) and tantalum-containing barrier layer materials, relative to dielectric materials, as readily determinable by one skilled in the art. Importantly, if metal material is exposed during CMP processing, the removal composition preferably further includes at least one metal passivator species, e.g., copper passivator species. Contemplated copper passivator species include, but are not limited to, 1,2,4-triazole, benzotriazole (BTA), tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, 2-mercaptobenzoimidizole (MBI), 2-mercaptobenzothiazole, 4-methyl-2-phenylimidazole, 2-mercaptothiazoline, 5-aminotetrazole (ATA), 5-amino-1,3,4-thiadiazole-2-thiol, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, mercaptobenzothiazole, imidazoline thione, mercaptobenzimidazole, 4-methyl-4H-1,2,4-triazole-3-thiol, 5-amino-1,3,4-thiadiazole-2-thiol, benzothiazole, tritolyl phosphate, indiazole, and combinations thereof. Dicarboxylic acids such as malonic acid, succinic acid, nitrilotriacetic acid, iminodiacetic acid, and combinations thereof are also useful copper passivator species. For example, the CMP polishing slurry may include at least one fluoride source, at least one low-k passivating agent, at least one oxidizing agent, at least one copper passivator species, abrasive material, and water. It is also contemplated herein that the removal compositions of the invention may be diluted with a solvent, such as water, and used as a post-chemical mechanical polishing (CMP) composition to remove post-CMP residue including, but not limited to, particles from the polishing slurry, carbon-rich particles, polishing pad particles, brush deloading particles, equipment materials of construction particles, copper, copper oxides, and any other materials that are the by-products of the CMP process. When used in post-CMP applications, the concentrated removal compositions may be diluted in a range from about 1:1 to about 1000:1 solvent to concentrate, wherein the solvent can be water and/or organic solvent.

In yet another alternative, the removal compositions of the invention may be formulated to substantially remove post-etch residue, including titanium-containing residue, from the surface of the microelectronic device without substantially damaging the underlying ILD, metal interconnect materials, and/or hardmask layers. Alternatively, the composition may be formulated to remove hardmask layers comprising titanium nitride and/or titanium oxynitride from the surface of the microelectronic device without substantially damaging the underlying low-k dielectric and metal interconnect materials.

Another aspect of the invention relates to the improved microelectronic devices made according to the methods of the invention and to products containing such microelectronic devices.

A still further aspect of the invention relates to methods of manufacturing an article comprising a microelectronic device, said method comprising contacting the microelectronic device with a removal composition for sufficient time to remove heater material, e.g., TiSiN, from the microelectronic device having said material thereon, and incorporating said microelectronic device into said article, wherein the removal composition includes at least one fluoride source, at least one low-k passivating agent, at least one oxidizing agent, water, and optionally at least one buffering agent.

The features and advantages of the invention are more fully illustrated by the following non-limiting examples, wherein all parts and percentages are by weight, unless otherwise expressly stated.

### Example 1

The etch rates of blanketed TiSiN, Si₃N₄ and TEOS in Formulations A-O was determined. The thicknesses of the blanketed materials were measured before and after immersion in Formulations A-O at temperatures ranging from 47.5° C. to 62.5° C. The length of the immersion of TiSiN, Si₃N₄ and TEOS in the respective formulation was 2 min, 10 min, and 20 min, respectively. Thicknesses were determined using a 4-point probe measurement whereby the resistivity of the composition is correlated to the thickness of the film remaining and the etch rate calculated therefrom. The experimental etch rates are reported in Table 1.

TABLE 1
Etch rate of TiSiN, Si₃N₄, and TEOS in Å min⁻¹
after immersion in Formulations A-O.

| | temperature/ | Etch rate/Å min⁻¹ | | | selectivity |
|---|---|---|---|---|---|
| Formulation | ° C. | TiSiN | Si₃N₄ | TEOS | TiSiN:SiN |
| A | 50 | 52.9 | 6.3 | 1.6 | 8:1 |
| A | 60 | 110.0 | 15.1 | 1.2 | 7:1 |
| B | 50 | 58.6 | 7.9 | 1.5 | 7:1 |
| B | 60 | 109.2 | 12.7 | 0.0 | 9:1 |
| C | 50 | 59.5 | 23.1 | 1.2 | 3:1 |
| C | 60 | 154.0 | 34.5 | 0.7 | 4:1 |
| D | 50 | 118.1 | 23.0 | 0.5 | 5.1 |
| D | 60 | 243.4 | 39.2 | 2.0 | 6:1 |
| E | 50 | 34.4 | 3.1 | 0.4 | 11:1 |
| E | 60 | 93.0 | 5.8 | 1.6 | 16:1 |
| F | 50 | 62.4 | 2.9 | 0.0 | 21:1 |
| F | 60 | 161.5 | 6.2 | 1.0 | 26:1 |
| G | 50 | 46.9 | 12.6 | 0.6 | 4:1 |
| G | 60 | 89.5 | 24.5 | 0.5 | 4:1 |
| H | 50 | 90.1 | 12.5 | 0.7 | 7:1 |
| H | 60 | 148.6 | 25.2 | 0.2 | 6:1 |
| I | 55 | 91.3 | 18.8 | 0.0 | 5:1 |
| I | 55 | 65.5 | 8.3 | 0.2 | 8:1 |
| I | 47.5 | 47.5 | 44.3 | 0.0 | 6:1 |
| I | 62.5 | 170.1 | 18.1 | 0.8 | 9:1 |
| J | 55 | 81.2 | 29.3 | 1.7 | 3:1 |
| K | 55 | 69.0 | 8.4 | 0.9 | 8:1 |
| L | 55 | 28.2 | 15.7 | 0.2 | 2:1 |
| M | 55 | 118.5 | 18.4 | 4.2 | 6:1 |
| N | 55 | 42.3 | 13.5 | 0.0 | 3:1 |
| O | 55 | 152.1 | 15.0 | 1.0 | 10:1 |

Pareto of coefficients analysis on the data in Table 1 revealed that the temperature, the concentration of H₂O₂, and the concentration of fluoroboric acid were the most important set of factors, in that order, influencing the TiSiN etch rate. The concentration of fluoroboric acid, the concentration of boric acid, and the temperature were the most important set of factors, in that order, influencing the Si₃N₄ etch rate. The etch rate of TEOS was low regardless of the temperature and/or concentration of formulation components.

Referring to Table 1, it can be seen that the formulation that provided the best selectivity of TiSiN:Si₃N₄ was formulation F. Knowing this, a patterned wafer including a proprietary TiSiN material, Si₃N₄, and TEOS was immersed in Formulation F for 7 min at 50° C., 55° C., and 60° C. It was determined that the etch at 50° C. removed about 670 Å of TiSiN, the etch at 55° C. removed about 1190 Å of TiSiN, and the etch at 60° C. removed about 2330 Å of TiSiN from the patterned wafer.

### Example 2

The etch rates of patterned wafers including a proprietary TiSiN material, Si₃N₄ and TEOS in Formulations P—W was determined. The wafers were immersed in formulations P—W for 7 min to 14 min at 55° C. and the depth of the heater material “pore” in the center and the edge was measured (see, e.g., FIG. 2). The “delta” represents the absolute difference between the edge measurement and the center measurement. The experimental results are reported in Table 2.

TABLE 2
Depth at center and edge of the heater material pore
after immersion in Formulations P-W.

| | | | Etch/Å | | |
|---|---|---|---|---|---|
| Formulation | pH | Time/min | Center | Edge | Delta |
| P | 1 | 7 | 840 | 1160 | 320 |
| P | 1 | 10 | 970 | 1320 | 360 |
| P | 1 | 14 | 2320 | 2320 | 0 |
| Q^{‡} | 3 | 10 | 470 | 520 | 50 |
| Q^{‡} | 3 | 12 | 570 | 950 | 380 |
| Q^{‡} | 3 | 15 | 690 | 1180 | 480 |
| R | 1 | 10 | 1460 | 1820 | 360 |
| S | 1 | 10 | 660 | 880 | 220 |
| S | 1 | 10 | 820 | 1150 | 340 |
| T | 1 | 10 | 700 | 1020 | 320 |
| U | 1 | 10 | 990 | 1450 | 460 |
| V | 1 | 10 | 880 | 1200 | 320 |
| W^{‡} | 3 | 15 | 860 | 1150 | 290 |
| X^{‡} | 3 | 15 | 550 | 670 | 130 |
| X^{‡} | 6 | 15 | 1080 | 1500 | 420 |
| Y^{‡} | 3 | 15 | 500 | 820 | 320 |
| Y^{‡} | 6 | 10 | 1150 | 1640 | 490 |
| Z^{‡} | 3 | 15 | 620 | 810 | 200 |
| Z^{‡} | 6 | 15 | 1100 | 1610 | 510 |
| AA^{‡} | 3 | 10 | 660 | 960 | 300 |
| AA^{‡} | 6 | 10 | 1480 | 1930 | 460 |

^{‡}contains buffer.

Referring to Table 2, it can be seen that the delta values, which should preferably approach zero, are on average about 300 Å. It was postulated that the deeply etched edges, also referred to as “crevice corrosion,” may have been a function of the TiSiN compound deposited as the heater material and not the formulations per se (with or without buffer). With regards to the buffered formulations, the solutions buffered to pH 3 are preferred over the solutions buffered to pH 6, although this is relative to the proprietary nature of heater material.

### Example 3

Electrochemical studies of blanketed TiSiN were performed whereby the wafers were immersed in formulations at 55° C. and the potential and current were recorded in response to voltage perturbations. The corrosion current density and hence the etch rate, in A min⁻¹, were determined. All calculations were performed assuming pure titanium. The corrosion rates, in A min⁻¹, are reported in Table 3 below (buffer 3 is 0.1 M phosphoric acid in ammonium hydroxide). The control was Formulation P.

TABLE 3
Corrosion rate of TiSiN in various formulations.

| Formulation | Corrosion rate/Å min⁻¹ |
|---|---|
| Control, pH 1 | 6.93 |
| Control + buffer 1, pH 3 | 4.20 |
| Control, pH 3 | 5.10 |
| Control + buffer 2, pH 3 | 2.68 |
| Control + buffer 3, pH 3 | 4.94 |

It can be seen that the addition of buffers, especially buffer 2, assisted in inhibiting titanium corrosion.

### Example 4

The etch rates of patterned wafers including a proprietary TiSiN material, Si₃N₄ and TEOS in Formulation AB was determined. Wafer 1 and wafer 2 were immersed in formulation AB for 7 min to 11 min at 45° C. and the depth of the heater material “pore” in the center and the edge was measured (see, e.g., FIG. 2). The experimental results are reported in Table 4. The deposition surfaces of wafer 1 and wafer 2 were prepared slightly different.

TABLE 4
Depth at center and edge of the heater material pore after
immersion in Formulation AB.

| | | Etch/Å | | |
|---|---|---|---|---|
| Wafer | Time/min | Center | Edge | Delta |
| 1 | 7 | 790 ± 190 | 570 ± 20 | |
| 1 | 9 | 660 ± 20 | — | |
| 1 | 11 | 1020 ± 140 | 990 ± 90 | |
| 2 | 7 | 520 ± 10 | — | |
| 2 | 9 | 680 ± 10 | — | |
| 2 | 11 | 810 ± 50 | — | |

Although edge depths were not determined for wafer 2 immersions, scanning electron micrographs verify that the TiSiN was etched evenly, i.e., the difference between the center and the edge approaches zero, within experimental error.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

1. An aqueous removal composition comprising at least one fluoride source, at least one passivating agent, and at least one oxidizing agent.

2. The aqueous removal composition of claim 1, wherein said aqueous removal composition etchingly removes heater material from a microelectronic device having same thereon, wherein the heater material comprises material selected from the group consisting of nc-MN/a-Si₃N₄, SiGe alloys, NiCr, Ta, AlTiN, and TaSiN, and combinations thereof, wherein M comprises a metal selected from the group consisting of Ti, W, V, Nb, Zr, and combinations thereof.

3. The aqueous removal composition of claim 1, wherein the at least one fluoride source, at least one passivating agent, and at least one oxidizing agent are present in amounts effective to achieve an etch rate of TiSiN in a range from about 100 Å min⁻¹ to about 200 Å min⁻¹ at temperatures in a range from about 30° C. to about 70° C.

4. The aqueous removal composition of claim 1, wherein pH is in a range from about 0 to about 4.5.

5. The aqueous removal composition of claim 1, wherein the at least one fluoride source comprises a fluoro-containing species selected from the group consisting of hydrofluoric acid, ammonium fluoride, ammonium bifluoride, fluoroboric acid, fluorosilicic acid, and combinations thereof.
wherein the at least one passivating agent comprises a species selected from the group consisting of boric acid, 3-hydroxy-2-naphthoic acid, malonic acid, iminodiacetic acid, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, and combinations thereof; and
wherein the at least one oxidizing agent comprises a species selected from the group consisting of hydrogen peroxide, oxone, oxone tetrabutylammonium salt, ferric nitrate, potassium iodate, potassium permanganate, nitric acid, ammonium chlorite, ammonium chlorate, ammonium iodate, ammonium perborate, ammonium perchlorate, ammonium periodate, ammonium persulfate, sodium persulfate, potassium persulfate, tetramethylammonium chlorite, tetramethylammonium chlorate, tetramethylammonium iodate, tetramethylammonium perborate, tetramethylammonium perchlorate, tetramethylammonium periodate, tetramethylammonium persulfate, urea hydrogen peroxide, peracetic acid, N-methylmorpholine-N-oxide (NMMO); trimethylamine-N-oxide; triethylamine-N-oxide; pyridine-N-oxide; N-ethylmorpholine-N-oxide; N-methylpyrrolidine-N-oxide; N-ethylpyrrolidine-N-oxide, and combinations thereof.

6. The aqueous removal composition of claim 1, comprising fluoroboric acid, boric acid, and hydrogen peroxide.

7. (canceled)

8. The aqueous removal composition of claim 1, wherein the composition is devoid of a species selected from the group consisting of oxalic acid, chlorine-containing compounds, monoethanolamine, monoethanolammonium salt, persulfate, abrasive material, and combinations thereof.

9. (canceled)

10. (canceled)

11. The aqueous removal composition of claim 1, further comprising at least one additional component selected from the group consisting of at least one buffering agent, at least one pH adjusting agent, at least one chelating agent, and combinations thereof.

12. The aqueous removal composition of claim 1, further comprising heater material residue.

13.-15. (canceled)

16. A method of removing heater material from a microelectronic device having said material thereon, said method comprising contacting the microelectronic device with an aqueous removal composition for sufficient time and under sufficient contacting conditions to at least partially remove said material from the microelectronic device, wherein the aqueous removal composition includes at least one fluoride source, at least one passivating agent, and at least one oxidizing agent.

17. The method of claim 16, wherein the heater material comprises material selected from the group consisting of nc-MN/a-Si₃N₄, SiGe alloys, NiCr, Ta, AlTiN, and TaSiN, and combinations thereof, wherein M comprises a metal selected from the group consisting of Ti, W, V, Nb, Zr, and combinations thereof.

18. The method of claim 16, wherein said contacting comprises conditions selected from the group consisting of: time of from about 1 minute to about 30 minutes; temperature in a range of from about 40° C. to about 70° C.; and combinations thereof.

19. The method of claim 16, wherein said removal composition has a pH in a range of from about 0 to about 4.5.

20. The method of claim 16, wherein the contacting comprises a process selected from the group consisting of: spraying the removal composition on a surface of the microelectronic device; dipping the microelectronic device in a sufficient volume of removal composition; contacting a surface of the microelectronic device with another material that is saturated with the removal composition; and contacting the microelectronic device with a circulating removal composition.

21. (canceled)

22. (canceled)

23. The method of claim 16, wherein the aqueous removal composition comprises fluoroboric acid, boric acid, and hydrogen peroxide

24. The method of claim 16, further comprising at least one additional component selected from the group consisting of at least one buffering agent, at least one pH adjusting agent, at least one chelating agent, and combinations thereof.

25. The method of claim 16, wherein the removal composition further comprises heater material residue.

26. The aqueous removal composition of claim 1, comprising boric acid.

27. The aqueous removal composition of claim 1, comprising fluoroboric acid.

28. The aqueous removal composition of claim 1, comprising hydrogen peroxide.
